(19) United States
(12) Patent Application Publication
(10) Pub. No.: US 2025/0024783 A1
(43) Pub. Date: Jan. 23, 2025

(54) WINDROWER IMPLEMENT WITH MERGER ATTACHMENT, AND METHOD OF CONTROLLING THE MERGER ATTACHMENT

(71) Applicant: DEERE & COMPANY, MOLINE, IL (US)

(72) Inventors: Mahi Agrawal, PUNE (IN); Ashwini Phalke, PUNE (IN); HUNTER T. KELDERMAN, OTTUMWA, IA (US); Tyler J. Bouslog, Keota, IA (US)

(21) Appl. No.: 18/354,996

(22) Filed: Jul. 19, 2023

(51) Int. Cl. A01D 57/20; A01D 84/00

(52) U.S. Cl. CPC A01D 57/20; A01D 84/00

(57) ABSTRACT

A windrower implement includes a merger attachment coupled to a frame rearward of an implement head. The merger attachment includes a conveyor positioned relative to the implement head to receive discharged crop material from the implement head and convey the crop material laterally relative to the central longitudinal axis to form a windrow laterally offset from the central longitudinal axis. A merger controller is operable to determine a location of a windrow formed during a belly pass and save the location of the windrow as a windrow track location. The merger control algorithm may determine a current position of the conveyor relative to the windrow track location and control a current speed of the conveyor based on the windrow track location of the belly pass and the current position of the conveyor to achieve a desired throw distance of crop material discharged from the conveyor.

### TECHNICAL FIELD

The disclosure generally relates to a windrower implement having a merger attachment, and a method of controlling the merger attachment.

### BACKGROUND

A windrower implement is an agricultural machine that cuts standing crop material while moving through a field, and forms the cut crop material into a swath or windrow. Typically, the windrower implement forms the windrow on and along a general longitudinal centerline of the windrower implement, generally between the left and right ground engaging devices, e.g., tires or tracks. The windrower implement may be equipped with a merger attachment. The merger attachment is configured to form the windrow laterally offset from the centerline of the windrower implement, generally outside the left or right ground engaging devices. The merger attachment may be deployed to form the windrow at an offset position relative to the centerline of the windrower implement, or may be stowed and disengaged, whereby the windrow is formed generally along the centerline of the windrower implement.

When harvesting crop material from a field, the windrower implement typically makes several parallel passes through the field with each pass cutting a width of the crop material. An operator of the windrower implement may control the windrower implement to execute a single pass windrow configuration in which the operator keeps the merger attachment continuously disengaged for each respective pass such that each respective pass through the field generates a respective windrow aligned with the longitudinal centerline of the windrower implement during that respective pass. The operator may alternatively control the windrower implement to execute a double pass windrow configuration in which the operator disengages the merger attachment while executing a belly pass, whereby the windrow is formed along the centerline of the windrower implement. After completing the belly pass, the operator aligns the windrower implement immediately adjacent to the belly pass with the merger attachment deployed to execute a first merger pass. While executing the first merger pass, the merger attachment deposits the crop material from the first merger pass on or next to the windrow formed from the belly pass, thereby placing the windrow from two adjacent passes through the field together as a single windrow.

While the multiple passes through the field are generally parallel, some deviations in each pass and/or in adjacent paths may occur. As such, each pass may not be perfectly linear, and each adjacent path may not be perfectly parallel. For example, obstacles in the field, ground contours, operator deviation, etc., may cause a centerline of adjacent paths followed through the field to vary from perfectly parallel. In addition, crop conditions throughout the field, e.g., crop volume, density, moisture content, etc., are constantly changing. When executing a double pass windrow operation, variations between the centerlines of adjacent paths, i.e., the belly pass and the first merger pass, may affect the distance the crop material is discharged from the merger attachment. For example, an increase in the distance between the belly pass and the first merger pass may cause the crop material discharged from the merger attachment to fall short of the windrow, thereby failing to properly form a single windrow during the double pass windrow operation. In addition, changing crop conditions may further affect the distance the crop material is discharged from the merger attachment.

### SUMMARY

A windrower implement is provided. The windrower implement includes a frame extending along a central longitudinal axis between a forward end and a rearward end relative to a direction of travel during operation. An implement head is attached to the frame proximate the forward end thereof. The implement head is operable to cut standing crop material and discharge cut crop material in a rearward direction along the central longitudinal axis. A merger attachment is coupled to the frame rearward of the implement head. The merger attachment includes a conveyor moveable between a deployed position and a stowed position. When the conveyor is disposed in the deployed position, the conveyor is positioned relative to the implement head to receive discharged crop material from the implement head and convey the crop material laterally relative to the central longitudinal axis to form a windrow laterally offset from the central longitudinal axis. When the conveyor is disposed in the stowed position, the conveyor is positioned relative to the implement head to not receive discharged crop material from the implement head to form the windrow substantially aligned with the central longitudinal axis along a center line of the frame. A merger controller includes a processor and a memory having a merger control algorithm stored thereon. The processor is operable to execute the merger control algorithm to determine a location of a windrow formed during a belly pass and save the location of the windrow formed during the belly pass in the memory as a windrow track location. When executing a merger pass adjacent to the belly pass, the merger control algorithm is operable to determine a current position of the conveyor relative to the windrow track location of the belly pass, and control a current speed of the conveyor based on the windrow track location of the belly pass and the current position of the conveyor to achieve a desired throw distance of crop material discharged from the conveyor.

In one aspect of the disclosure, the processor is operable to execute the merger control algorithm to calculate the desired throw distance from the windrow track location of the belly pass and the current position of the conveyor. For example, the merger controller may calculate the desired throw distance by calculating a perpendicular distance between the windrow track location of the belly pass and the current position of the conveyor.

In one aspect of the disclosure, the processor is operable to execute the merger control algorithm to define a desired speed based on the desired throw distance and a current mass flow rate of the crop material currently being moved by the conveyor. The merger controller may then control the current speed of the conveyor to achieve the desired speed.

In one aspect of the disclosure, the processor is operable to execute the merger control algorithm to define a baseline speed of the conveyor for a baseline throw distance and a baseline crop mass flow rate. The merger controller may define the desired speed to be greater than the baseline speed when the desired throw distance is greater than the baseline throw distance. The merger controller may define the desired speed to be less than the baseline speed when the desired throw distance is less than the baseline throw distance. The merger controller may define the desired speed to be greater than the baseline speed when a current mass flow rate of the crop material being moved by the conveyor is greater than the baseline crop volume. The merger controller may define the desired speed to be less than the baseline speed when a current mass flow rate of the crop material being moved by the conveyor is less than the baseline crop mass flow rate.

In one aspect of the disclosure, the windrower implement may include a flow sensor operable to detect data related to a mass flow rate of the crop material currently being moved by the conveyor. The flow sensor may include, but is not limited to, a image sensing device such as but not limited to a camera, a Near InfraRed Camera, a weight sensor, a timer, etc.

In one aspect of the disclosure, the windrower implement may include a location sensor. The location sensor may be operable to detect data related to a location of the conveyor. The processor is operable to execute the merger control algorithm to determine a current location of the conveyor from the data detected by the location sensor. The location sensor may include, for example, a Global Positioning Satellite (GPS) system.

A method of controlling a merger attachment of a windrower implement is also provided. The merger attachment includes a conveyor for discharging crop material. The method includes determining a location of a windrow formed during a belly pass with a merger controller, and saving the location of the windrow formed during the belly pass in a memory of the merger controller as a windrow track location. The merger controller may then identify execution of a merger pass adjacent to the belly pass. When executing the merger pass, the merger controller may determine a current position of the conveyor relative to the windrow track location of the belly pass. The merger controller may then control a current speed of the conveyor based on the windrow track location of the belly pass and the current position of the conveyor to achieve a desired throw distance of crop material discharged from the conveyor.

In one aspect of the disclosure, the method of controlling the merger attachment may include calculating the desired throw distance from the windrow track location of the belly pass and the current position of the conveyor with the merger controller.

In one aspect of the disclosure, the method of controlling the merger attachment may include defining a desired speed of the conveyor based on the desired throw distance and a current mass flow rate of the crop material currently being moved by the conveyor with the merger controller.

In one aspect of the disclosure, the method of controlling the merger attachment may include controlling the current speed of the conveyor based on the windrow track location of the belly pass and the current position of the conveyor to achieve a desired throw distance of crop material discharged from the conveyor includes controlling the current speed of the conveyor to achieve the desired speed of the conveyor with the merger controller.

In one aspect of the disclosure, the method of controlling the merger attachment may include defining a baseline speed of the conveyor for a baseline throw distance and a baseline crop mass flow rate. The merger controller may then define the desired speed to be greater than the baseline speed when the desired throw distance is greater than the baseline throw distance. The merger controller may define the desired speed to be less than the baseline speed when the desired throw distance is less than the baseline throw distance. The merger controller may define the desired speed to be greater than the baseline speed when a current mass flow rate of the crop material being moved by the conveyor is greater than the baseline crop mass flow rate. The merger controller may define the desired speed to be less than the baseline speed when a current mass flow rate of the crop material being moved by the conveyor is less than the baseline crop mass flow rate.

Accordingly, the windrower implement and the method described herein enable the speed of the conveyor of the merger attachment to be changed in order to achieve a desired throw distance so that the crop material discharged from the merger attachment falls onto the windrow formed from a previous pass, thereby forming a uniform combined windrow. The speed of the conveyor may be altered based on the distance between the conveyor and the adjacent windrow, and/or in combination with the mass flow rate of crop material being moved by the conveyor. The windrower implement and the method described herein enable the automatic adjustment of the conveyor of the merger attachment to account for changing conditions and/or variables encountered while processing the crop material, such as but not limited to non-parallel paths, change in crop conditions, ground slope, etc., while maintaining a uniform combined windrow during a double pass windrow operation.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a windrower implement.

FIG. 2 is a cross sectional view of the windrower implement.

FIG. 3 is a schematic plan view of the windrower implement executing a double pass windrow operation in a field.

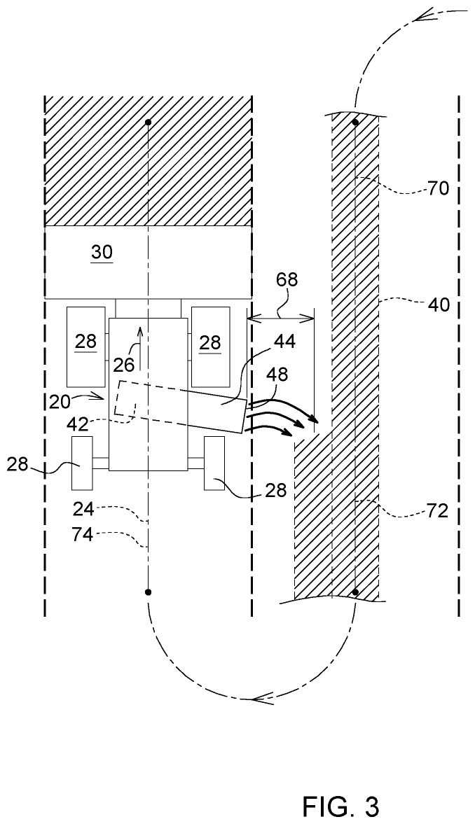

FIG. 4 is a flow diagram representing a method of controlling a merger attachment of the windrower implement.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

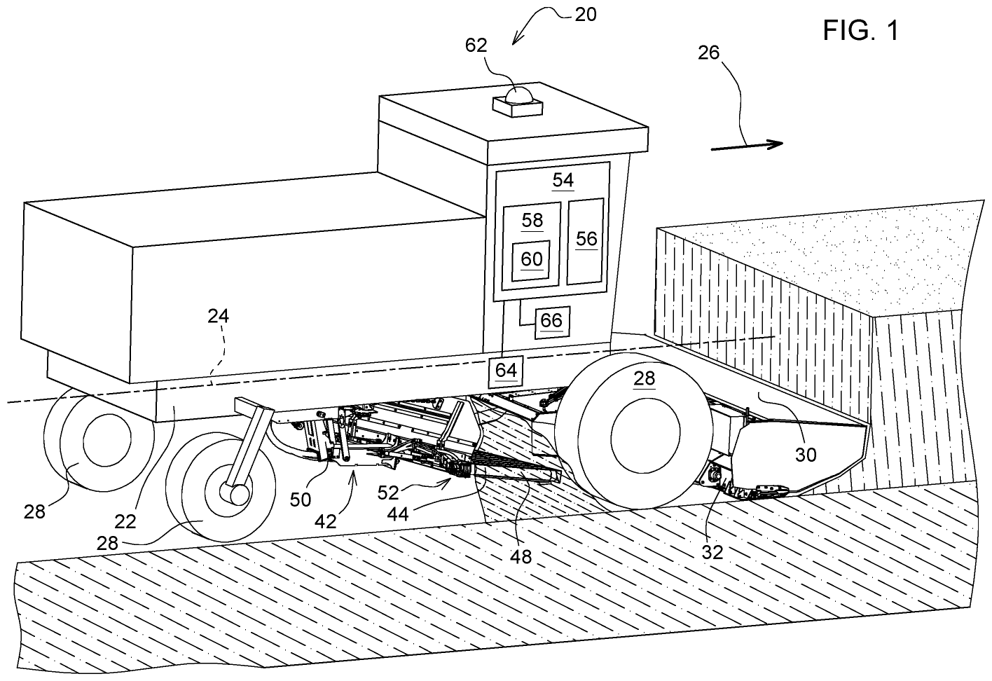

Referring to the Figures, wherein like numerals indicate like parts throughout the several views, a windrower implement is generally shown at 20 in FIG. 1. The exemplary embodiment of the windrower implement 20 shown in the Figures is configured as a self-propelled windrower. However, it should be appreciated that the teachings of this disclosure may be applied to other platforms, such as but not limited to, a drawn implement configured for connection to a tractor. In one implementation, the windrower implement 20 is operable to mow and collect standing crop material in a field, condition the cut crop material as it moves through the windrower implement 20 to improve is drying characteristics, and then return the conditioned, cut crop material to the field in a windrow 40 or swath.

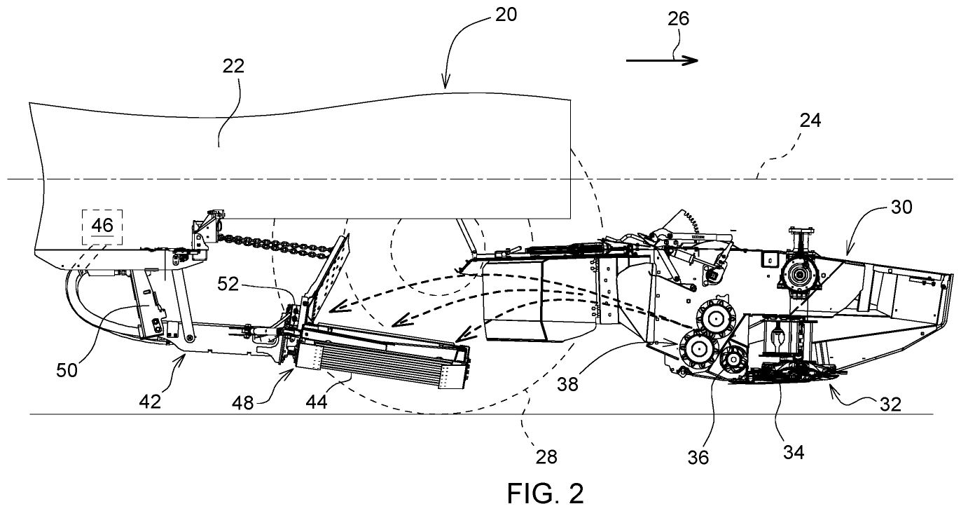

Referring to FIGS. 1-2, the example implementation of the windrower implement 20 includes a frame 22. The frame 22 extends along a central longitudinal axis 24 between a forward end and a rearward end relative to a direction of travel 26 during operation. The central longitudinal axis 24 defines a longitudinal centerline of the windrower implement 20. The frame 22 may include, but is not limited to, the various members, panels, supports, braces, beams, etc., necessary to support the various components and systems of the windrower implement 20 as described below. The windrower implement 20 includes ground engaging devices 28, e.g., tires and/or tracks, which support the frame 22 relative to a ground surface. The ground engaging devices 28 may be powered to move the windrower implement 20 across the ground surface.

The windrower implement 20 further includes an implement head 30. The implement head 30 is attached to the frame 22 proximate the forward end of the frame 22. The implement head 30 is operable to discharge crop material in a rearward direction generally along the central longitudinal axis 24. In addition, the implement head 30 may further cut the crop material and condition the crop material to aid in dry down.

In one implementation, the implement head 30 may include, but is not limited to, a cutting mechanism 32. The cutting mechanism 32 is coupled to the frame 22 and is operable to cut standing crop material in a field. The cutting mechanism 32 may include any mechanism that is capable of cutting the crop material. For example, the cutting mechanism 32 may be embodied as a rotary disc cutter bar 34. However, the cutting mechanism 32 is not limited to the exemplary embodiment of the rotary disc cutter bar 34. As such, it should be appreciated that the cutting mechanism 32 may vary from the exemplary embodiment noted herein.

As understood in the art, the rotary disc cutter is supported by the frame 22. The cutter bar 34 extends along an axis that is disposed generally transverse to the direction of travel 26 of the windrower implement 20. The cutter bar 34 includes a plurality of cutting discs spaced along the cutter bar 34 for rotation about respective vertical axes. Each of the cutting discs is coupled to a drivetrain to which power is coupled for causing them to rotate in appropriate directions, for delivering cut crop material to an auger 36 disposed rearward of the cutting mechanism 32.

The auger 36 may pass the crop material rearward to a crop conditioning system 38. In particular, the auger 36 may be positioned in front of and lower than the crop conditioning system 38. In operation, the design of the auger 36 enables the delivery of cut crop material into the crop conditioning system 38. The cutting mechanism 32 delivers cut crop material to the auger 36, which in turn may delivers the cut crop material rearward for further processing by the crop conditioning system 38. The crop conditioning system 38 may include, but is not limited to, an impeller style conditioning system or a pair of counter rotating conditioner rolls, as is understood in the art. The conditioned crop material is expelled rearward by the crop conditioning system 38, and may be formed into the windrow 40 or swath by upright right and left forming boards and a swath board. The cut and conditioned crop material is expelled or discharged from the crop conditioning system 38 in the rearward direction, whereafter the crop material moves a short distance through the air before accumulating on the ground in the formed windrow 40.

Referring to FIGS. 1-2, the windrower implement 20 includes a merger attachment 42. The merger attachment 42 is coupled to the frame 22 rearward of the implement head 30. The merger attachment 42 includes a conveyor 44 that is moveable between a deployed position and a stowed position. When the conveyor 44 is disposed in the deployed position, the conveyor 44 is positioned relative to the implement head 30 to receive discharged crop material from the implement head 30 and convey the crop material laterally relative to the central longitudinal axis 24 to form the windrow 40 laterally offset from the central longitudinal axis 24. When the conveyor 44 is disposed in the stowed position, the conveyor 44 is positioned relative to the implement head 30 to not receive discharged crop material from the implement head 30 to form the windrow 40 substantially aligned with the central longitudinal axis 24 along the centerline of the windrower implement 20.

The conveyor 44 of the merger attachment 42 may be positioned such that the crop material discharged from the crop conditioning system 38 falls on the conveyor 44 instead of the ground. The crop material discharged from the crop conditioning system 38 is disposed generally along a longitudinal centerline of the windrower implement 20, between left and right ground engaging devices 28 of the windrower implement 20. The conveyor 44 is rotatably driven by an actuator 46, such as but not limited to an electric or hydraulic motor, and may include, for example, a rotatable endless belt, which is operable to convey the crop material laterally relative to the longitudinal centerline of the windrower implement 20, and deposit the crop material on the ground at a laterally offset position relative to the central longitudinal axis 24 of the frame 22 and the centerline of the windrower implement 20. The crop material is discharged from the implement head 30 and falls onto the conveyor 44 of the merger attachment 42. The conveyor 44 moves or rotates to move the crop disposed thereon laterally outward away from the centerline of the windrower implement 20. The crop on the conveyor 44 is deposited or discharged off a distal end 48 of the conveyor 44, whereafter the crop falls to the ground forming the windrow 40 which is laterally offset from the centerline of the windrower implement 20.

The merger attachment 42 may include a lift structure 50 and a support structure 52. The support structure 52 includes the conveyor 44 for moving the crop material. The lift structure 50 may interconnect the frame 22 of the windrower implement 20 and the support structure 52. The lift structure 50 may be configured to selectively position the support structure 52 and the conveyor 44 thereof in the stowed position and the deployed position. When disposed in the stowed position, the lift structure 50 may position the support structure 52 tightly against the belly of the frame 22, such that the conveyor 44 of the support structure 52 does not engage the cut crop material discharged from the implement head 30 and the windrow 40 may be formed along the central longitudinal axis 24 of the frame 22, i.e., generally along the centerline of the windrower implement 20. When disposed in the deployed position, the lift structure 50 may position the conveyor 44 of the support structure 52 near the ground surface, such that the crop material discharged from the implement head 30 falls on the conveyor 44 of the support structure 52 for lateral movement relative to the central longitudinal axis 24, whereby the windrow 40 may be formed laterally offset form the central longitudinal axis 24. The features, components, structure, and operation of the lift structure 50 and the support structure 52 are understood by those skilled in the art, are not pertinent to the teachings of this disclosure, and are therefore not described in detail herein.

Referring to FIG. 1, the windrower implement 20 further includes a merger controller 54. The merger controller 54 is operatively coupled to the merger attachment 42 for controlling movement of the merger attachment 42 between the deployed position and the stowed position, and for controlling the actuator 46 of the conveyor 44. The merger controller 54 is operable to receive inputs and data signals, and communicate a control signal to the lift structure 50 and the actuator 46 of the conveyor 44. While the merger controller 54 is generally described herein as a singular device, it should be appreciated that the merger controller 54 may include multiple devices linked together to share and/or communicate information therebetween. Furthermore, it should be appreciated that the merger controller 54 may be located on the windrower implement 20 or located remotely from the windrower implement 20.

The merger controller 54 may alternatively be referred to as a computing device, a computer, a controller, a control unit, a control module, a module, etc. The merger controller 54 includes a processor 56, a memory 58, and all software, hardware, algorithms, connections, sensors, etc., necessary to manage and control the operation of the location sensor 62, flow sensor 64, lift structure 50 of the merger attachment 42, and the actuator 46 of the conveyor 44. As such, a method may be embodied as a program or algorithm operable on the merger controller 54. It should be appreciated that the merger controller 54 may include any device capable of analyzing data from various sensors, comparing data, making decisions, and executing the required tasks.

As used herein, “merger controller 54” is intended to be used consistent with how the term is used by a person of skill in the art, and refers to a computing component with processing, memory, and communication capabilities, which is utilized to execute instructions (i.e., stored on the memory 58 or received via the communication capabilities) to control or communicate with one or more other components. In certain embodiments, the merger controller 54 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The merger controller 54 may be in communication with other components on the windrower implement 20, such as hydraulic components, electrical components, and operator inputs within an operator station of an associated work vehicle. The merger controller 54 may be electrically connected to these other components by a wiring harness such that messages, commands, and electrical power may be transmitted between the merger controller 54 and the other components. Although the merger controller 54 is referenced in the singular, in alternative embodiments the configuration and functionality described herein can be split across multiple devices using techniques known to a person of ordinary skill in the art.

The merger controller 54 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 58 may include any non-transitory/tangible medium which participates in providing data or computer-readable instructions. The memory 58 may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The merger controller 54 includes the tangible, non-transitory memory 58 on which are recorded computer-executable instructions, including a merger control algorithm 60. The processor 56 of the merger controller 54 is configured for executing the merger control algorithm 60. The merger control algorithm 60 implements a method of controlling the merger attachment 42, described in detail below.

The windrower implement 20 may further include a location sensor 62. The location sensor 62 is operable to detect data related to a location of the head implement and/or the frame 22 of the windrower implement 20. The location sensor 62 may include, but is not limited to, a Global Positioning System (GPS) device or other similar location sensor 62. The location sensor 62 is disposed in communication with the merger controller 54 for communicating data therebetween. As is understood by those skilled in the art, the location sensor 62 may detect data related to the position of the head implement over a period of time in order to determine a speed of movement and a direction of movement.

The windrower implement 20 may further include a flow sensor 64. The flow sensor 64 is operable to detect data related to a mass flow rate of the crop material currently being moved by the conveyor 44. As is understood by those skilled in the art, the flow sensor 64 may detect data related to the mass or quantity of crop material being moved by the conveyor 44 over or during a period of time. The flow sensor 64 may include, but is not limited to, an optical sensor for sensing one or more images, such as but not limited to a camera, a high speed camera, a video camera, a near infrared camera, etc. In other implementations, the flow sensor 64 may include, but is not limited to a weight sensor, a force sensor, a pressure sensor, etc. It should be appreciated that the flow sensor 64 may include a device or combination of devices that are capable of sensing the mass flow rate of the crop material and/or data related to the mass flow rate that enables the merger controller 54 to then calculate the mass flow rate. Accordingly, it should be appreciated that the flow sensor 64 may include a device or combination of devices not described herein. The flow sensor 64 is disposed in communication with the merger controller 54 for communicating data therebetween.

As described above, the processor 56 is operable to execute the merger control algorithm 60 to implement a method of controlling the merger attachment 42. The method disclosed herein includes selecting one of a single pass windrow 40 configuration or a double pass windrow 40 configuration. The merger controller 54 may automatically control the merger attachment 42 into the stowed position in preparation for executing a belly pass 72 for the single pass windrow 40 configuration or the double pass windrow 40 configuration. In order to do so, the merger controller 54 may signal the lift structure 50 to move the support structure 52 and the conveyor 44 thereof into the stowed position.

In one implementation, the merger controller 54 may query the operator to identify a beginning and/or an end of the belly pass 72. The operator may define the beginning and/or the end of the belly pass 72 via a user input 66, such as by pressing a button instructing the merger attachment 42 to use the current location of the windrower implement 20 as the beginning and/or the end of the belly pass 72, or by entering a desired track having a start location and an end location corresponding to the beginning of the belly pass 72 and the end of the belly pass 72 respectively.

Upon completion of the belly pass 72, the operator may align and position the windrower implement 20 relative to the belly pass 72 for a merger pass 74. Upon completion of the belly pass 72, the merger attachment 42 may automatically control the merger attachment 42 into the deployed position in preparation for executing the first merger pass 74.

The merger controller 54 may receive data from the location sensor 62, and therefrom determine a current location of the windrower implement 20 and/or head implement, speed of travel of the windrower implement 20, and direction of travel 26 or movement of the head implement. The merger controller 54 may track the location of the windrower implement 20 while executing the belly pass 72 to determine a location of the windrow 40 formed during the belly pass 72. The location of the windrow 40 formed during the belly pass 72 may then be saved in the memory 58 as a windrow track location 70.

The merger controller 54 may recognize the beginning of the merger pass 74 from the current location of the head implement, the direction of movement of the head implement and the windrow track location 70. For example, if the end of the belly pass 72 has been previously defined or is contemporaneously entered into the merger controller 54 by the operator, the merger controller 54 may then use the windrow track location 70 and the current position of the windrower implement 20 to determine and/or recognize the beginning of the merger pass 74. Upon recognizing the beginning of the merger pass 74, the merger controller 54 may control the merger attachment 42 into the deployed position in preparation of the merger pass 74 of the double pass windrow 40 configuration.

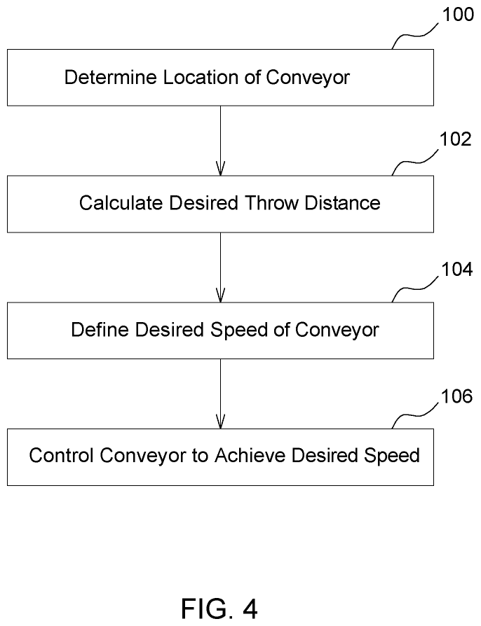

Referring to FIG. 4, when executing the merger pass 74 adjacent to the belly pass 72, the merger controller 54 may determine a current position of the conveyor 44 relative to the windrow track location 70 of the belly pass 72. The step of determining the current position of the conveyor 44 is generally indicated by box 100 shown in FIG. 4. In one implementation of the disclosure, the current position of the conveyor 44, e.g., the distal end 48 of the conveyor 44, may be determined and/or calculated using data sensed from the location sensor 62 and the known three-dimensional data relating the location of the distal end 48 of the conveyor 44 relative to the location sensor 62. It should be appreciated that the current position of the conveyor 44 may be determined in some other manner not described herein.

Once the location of the conveyor 44 relative to the windrow track location 70 is determined, the merger controller 54 may then calculate a desired throw distance 68. The step of calculating the desired throw distance is generally indicated by box 102 shown in FIG. 4. The desired throw distance 68 is the desired horizontal distance the crop material should travel through the air after being discharged from the conveyor 44 and before contacting the ground surface and/or the windrow 40 formed during the belly pass 72. The desired throw distance 68 may be calculated from the windrow track location 70 of the belly pass 72 and the current position of the conveyor 44. For example, the merger controller 54 may calculate the desired throw distance 68 by calculating a perpendicular distance between the windrow track location 70 of the belly pass 72 and the current position of the conveyor 44. It should be appreciated that the desired throw distance 68 may include other factors in the calculation thereof, including but not limited to an elevation profile of the ground surface, a ground speed of the windrower implement 20, an angular discharge trajectory of the conveyor 44 relative to the direction of travel 26 and relative to the elevation of the ground surface, wind direction and velocity, etc. The merger controller 54 may calculate the desired throw distance 68 using, but not limited to, geometric relationships and/or equations relating the windrow track location 70 and the position of the conveyor 44, equations of motion, equations of trajectory, etc.

When executing the merger pass 74 adjacent to the belly pass 72, the merger controller 54 may determine a mass flow rate. As noted above, the current mass flow rate is the quantity, volume, or mass of the crop material currently being moved by the conveyor 44 of the merger attachment 42. In one implementation of the disclosure, the current mass flow rate may be determined and/or calculated using data sensed from the flow sensor 64. It should be appreciated that the current mass flow rate may be determined in some other manner not described herein.

Once the desired throw distance 68 is calculated and/or otherwise determined, the merger controller 54 may then define a desired speed for the conveyor 44. The step of defining the desired speed of the conveyor 44 is generally indicated by box 104 shown in FIG. 4. The desired speed for the conveyor 44 may include a linear and/or angular rotational speed of the conveyor 44 necessary to project the discharged crop material form the conveyor 44 the desired throw distance 68. The desired speed for the conveyor 44 is the speed at which the conveyor 44 continuously rotates or moves during operation. The desired speed of the conveyor 44 may be based on the desired throw distance 68. Additionally, the desired speed of the conveyor 44 may further be based on the current mass flow rate of the crop material currently being moved by the conveyor 44.

The merger controller 54 may further define a baseline speed of the conveyor 44 for a baseline throw distance and a baseline crop mass flow rate. The baseline speed of the conveyor 44 may be defined to include an initial or default speed for operation of the conveyor 44 suitable for most operating conditions and may be based on the specific operating size and parameters of the windrower implement 20. The baseline throw distance of the conveyor 44 may be defined to include an initial or default throw distance for the merger attachment 42 suitable for most operating conditions, and may be based on the specific operating size and parameters of the windrower implement 20. The baseline crop mass flow rate of the conveyor 44 may be defined to include an initial or default mass flow rate suitable for most operating conditions and based on the specific operating size and parameters of the windrower implement 20.

The baseline speed of the conveyor 44, the baseline throw distance, and the baseline crop mass flow rate may be default values defined at time of manufacture of the windrower implement 20, may be entered by the operator via the user interface, or may be otherwise automatically determined by the merger controller 54, such as by automatically querying a communication tag to identify a make and model of the windrower implement 20, merger attachment 42, etc. In one implementation, he baseline speed of the conveyor 44, the baseline throw distance, and the baseline crop mass flow rate are manually entered by the operator at the beginning of a harvest operation.

Once the baseline speed of the conveyor 44, the baseline throw distance, and the baseline crop mass flow rate are defined, the merger controller 54 may then adjust the baseline speed to define the desired speed required to achieve the desired throw distance 68. For example, in one implementation, the merger controller 54 may define the desired speed to be greater than the baseline speed when the desired throw distance 68 is greater than the baseline throw distance. In another implementation, the merger controller 54 may define the desired speed to be less than the baseline speed when the desired throw distance 68 is less than the baseline throw distance. In another implementation, the merger controller 54 may define the desired speed to be greater than the baseline speed when the current mass flow rate of the crop material being moved by the conveyor 44 is greater than the baseline crop volume. In yet another implementation, the merger controller 54 may define the desired speed to be less than the baseline speed when the current mass flow rate of the crop material being moved by the conveyor 44 is less than the baseline crop mass flow rate.

The merger controller 54 may control a current speed of the conveyor 44 based on the windrow track location 70 of the belly pass 72 and the current position of the conveyor 44 to achieve the desired throw distance 68 of crop material discharged from the conveyor 44. The step of controlling the actuator 46 to achieve the desired speed of the conveyor 44 is generally indicated by box 106 shown in FIG. 4. Once the desired speed of the conveyor 44 has been defined, the merger controller 54 may control the current speed of the conveyor 44 to achieve the desired speed. The merger controller 54 controls the speed of the conveyor 44 by controlling the actuator 46 motivating the conveyor 44. As such, the merger controller 54 communicates a control signal to the actuator 46 to control the actuator 46 to achieve the desired speed. As described above, the desired speed of the controller is defined to achieve the desired throw distance 68 to land the crop material discharged from the conveyor 44 during the merger pass 74 onto or immediately adjacent to the windrow 40 formed during the belly pass 72. Accordingly, the windrower implement 20 and the process described herein automatically adjusts the speed of the conveyor 44 of the merger attachment 42 to achieve consistent placement of the crop material discharged from the conveyor 44 during the merger pass 74 for desirable combined windrow 40, thereby automatically accounting for variations between the path followed during the belly pass 72 and the path followed during the merger pass 74, e.g., non-parallel paths, as well as variations in crop density, crop moisture content, changes in ground elevation profile, etc. The consistent formation of the combined windrow 40 may improve and/or enable for efficient follow-up harvest operations.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A windrower implement comprising:
a frame extending along a central longitudinal axis between a forward end and a rearward end relative to a direction of travel during operation;
an implement head attached to the frame proximate the forward end thereof, wherein the implement head is operable to cut standing crop material and discharge cut crop material in a rearward direction along the central longitudinal axis;
a merger attachment coupled to the frame rearward of the implement head, wherein the merger attachment includes a conveyor moveable between a deployed position in which the conveyor is positioned relative to the implement head to receive discharged crop material from the implement head and convey the crop material laterally relative to the central longitudinal axis to form a windrow laterally offset from the central longitudinal axis, and a stowed position in which the conveyor is positioned relative to the implement head to not receive discharged crop material from the implement head to form the windrow substantially aligned with the central longitudinal axis along a center line of the frame;
a merger controller having a processor and a memory having a merger control algorithm stored thereon, wherein the processor is operable to execute the merger control algorithm to:
determine a location of a windrow formed during a belly pass and save the location of the windrow formed during the belly pass in the memory as a windrow track location;
when executing a merger pass adjacent to the belly pass, determine a current position of the conveyor relative to the windrow track location of the belly pass; and
control a current speed of the conveyor based on the windrow track location of the belly pass and the current position of the conveyor to achieve a desired throw distance of crop material discharged from the conveyor.

2. The windrower implement set forth in claim 1, wherein the processor is operable to execute the merger control algorithm to calculate the desired throw distance from the windrow track location of the belly pass and the current position of the conveyor.

3. The windrower implement set forth in claim 2, wherein the processor is operable to execute the merger control algorithm to calculate the desired throw distance by calculating a perpendicular distance between the windrow track location of the belly pass and the current position of the conveyor.

4. The windrower implement set forth in claim 2, wherein the processor is operable to execute the merger control algorithm to define a desired speed based on the desired throw distance and a current mass flow rate of the crop material currently being moved by the conveyor.

5. The windrower implement set forth in claim 4, wherein the processor is operable to execute the merger control algorithm to control the current speed of the conveyor to achieve the desired speed.

6. The windrower implement set forth in claim 1, wherein the processor is operable to execute the merger control algorithm to define a baseline speed of the conveyor for a baseline throw distance and a baseline crop mass flow rate.

7. The windrower implement set forth in claim 6, wherein the processor is operable to execute the merger control algorithm to define the desired speed to be greater than the baseline speed when the desired throw distance is greater than the baseline throw distance.

8. The windrower implement set forth in claim 6, wherein the processor is operable to execute the merger control algorithm to define the desired speed to be less than the baseline speed when the desired throw distance is less than the baseline throw distance.

9. The windrower implement set forth in claim 6, wherein the processor is operable to execute the merger control algorithm to define the desired speed to be greater than the baseline speed when a current mass flow rate of the crop material being moved by the conveyor is greater than the baseline crop volume.

10. The windrower implement set forth in claim 6, wherein the processor is operable to execute the merger control algorithm to define the desired speed to be less than the baseline speed when a current mass flow rate of the crop material being moved by the conveyor is less than the baseline crop mass flow rate.

11. The windrower implement set forth in claim 1, further comprising a flow sensor operable to detect data related to a mass flow rate of the crop material currently being moved by the conveyor.

12. The windrower implement set forth in claim 1, further comprising a location sensor operable to detect data related to a location of the conveyor, wherein the processor is operable to execute the merger control algorithm to determine a current location of the conveyor from the data detected by the location sensor.

13. A windrower implement comprising:
a frame extending along a central longitudinal axis between a forward end and a rearward end relative to a direction of travel during operation;
an implement head attached to the frame proximate the forward end thereof, wherein the implement head is operable to cut standing crop material and discharge cut crop material in a rearward direction along the central longitudinal axis;
a merger attachment coupled to the frame rearward of the implement head, wherein the merger attachment includes a conveyor positioned relative to the implement head to receive discharged crop material from the implement head and convey the crop material laterally relative to the central longitudinal axis;
a merger controller having a processor and a memory having a merger control algorithm stored thereon, wherein the processor is operable to execute the merger control algorithm to:
define a baseline speed of the conveyor for a baseline throw distance and a baseline crop mass flow rate;
define a desired speed of the conveyor to be greater than the baseline speed when a desired throw distance is greater than the baseline throw distance;
define the desired speed of the conveyor to be less than the baseline speed when the desired throw distance is less than the baseline throw distance; and
control a current speed of the conveyor to achieve the desired speed of the conveyor.

14. The windrower implement set forth in claim 13, wherein the processor is operable to execute the merger control algorithm to:
define the desired speed to be greater than the baseline speed when a current mass flow rate of the crop material being moved by the conveyor is greater than the baseline crop mass flow rate; and
define the desired speed to be less than the baseline speed when the current mass flow rate of the crop material being moved by the conveyor is less than the baseline crop mass flow rate.

15. A method of controlling a merger attachment of a windrower implement, the merger attachment including a conveyor for discharging crop material, the method comprising:
determining a location of a windrow formed during a belly pass with a merger controller, and saving the location of the windrow formed during the belly pass in a memory of the merger controller as a windrow track location;
identifying execution of a merger pass adjacent to the belly pass with the merger controller;
determining a current position of the conveyor relative to the windrow track location of the belly pass, when executing the merger pass, with the merger controller; and
controlling a current speed of the conveyor with the merger controller based on the windrow track location of the belly pass and the current position of the conveyor to achieve a desired throw distance of crop material discharged from the conveyor.

16. The method set forth in claim 15, further comprising calculating the desired throw distance from the windrow track location of the belly pass and the current position of the conveyor with the merger controller.

17. The method set forth in claim 16, further comprising defining a desired speed of the conveyor with the merger controller based on the desired throw distance and a current mass flow rate of the crop material currently being moved by the conveyor.

18. The method set forth in claim 17, wherein controlling the current speed of the conveyor based on the windrow track location of the belly pass and the current position of the conveyor to achieve a desired throw distance of crop material discharged from the conveyor includes controlling the current speed of the conveyor with the merger controller to achieve the desired speed of the conveyor.

19. The method set forth in claim 17, further comprising defining a baseline speed of the conveyor for a baseline throw distance and a baseline crop mass flow rate.

20. The method set forth in claim 19, further comprising:
defining, with the merger controller, the desired speed to be greater than the baseline speed when the desired throw distance is greater than the baseline throw distance;
defining, with the merger controller, the desired speed to be less than the baseline speed when the desired throw distance is less than the baseline throw distance;
defining, with the merger controller, the desired speed to be greater than the baseline speed when a current mass flow rate of the crop material being moved by the conveyor is greater than the baseline crop mass flow rate; and
defining, with the merger controller, the desired speed to be less than the baseline speed when a current mass flow rate of the crop material being moved by the conveyor is less than the baseline crop mass flow rate.
